(19) United States
(12) Patent Application Publication
(10) Pub. No.: US 2002/0000082 A1
(43) Pub. Date: Jan. 3, 2002

(54) GUIDE MECHANISM

(76) Inventor: ROGER THOMAS, SEDGEFIELD (GB)

Correspondence Address: HARNESS DICKEY & PIERCE PLC, P O BOX 828, BLOOMFIELD HILLS, MI, 48303

(21) Appl. No.: 09/350,594

(22) Filed: Jul. 9, 1999

(30) Foreign Application Priority Data
Jul. 11, 1998 (GB) 9814997.4

(51) Int. Cl. A01D 34/00; A01D 34/64

(52) U.S. Cl. 56/16.7; 56/322

(57) ABSTRACT

A lawn mower comprising a cutting deck mounted on castor wheel assemblies wherein the deck is mounted on four castor wheel assemblies each located in the region of a corner of the cutting deck preferably with two castor wheel assemblies located towards the front of the cutting deck and two are located towards the rear of the cutting deck. One pair of castor wheel assemblies mounted on one edge of the cutting deck are located closer to each other than the other pair of castor wheel assemblies mounted on the opposite edge of the cutting deck to form a trapezium. Ideally there is at least one friction reduction mechanism in the form of either a roller or rotatable ball mounted on at least one side of the cutting deck.

### TECHNICAL FIELD

The present invention relates to lawn mowers and, in particular, to lawn mowers mounted on castor wheels.

### DISCUSSION

Household lawn mowers comprise a cutting deck upon which is mounted a motor. The motor can be either an electric motor powered by either a main electricity supply or a battery, or an internal combustion engine. The motor rotatingly drives a cutting blade mounted below the cutting deck about a substantially vertical axis, to cut the grass beneath the deck as the blade rotates. The cutting deck is commonly mounted on wheels or rollers, having a fixed direction of travel so that the lawn mower moves over the lawn in a forward and reverse direction. Typically, where the mower has four wheels, these are located on the deck in a rectangular array.

One method of increasing the maneuverability of a mower is to mount the cutting deck of the mower on castor wheels which can freely swivel through 360° instead of wheels or rollers which have a predetermined fixed direction of travel. This allows the cutting deck of the mower to travel in any direction, both linearly and rotationally.

It is desirable to be able to cut the grass at the extreme edges of the lawn. This is achieved by moving the path swept out by the blade when it rotates over the edge of the lawn thereby enabling the blade to cut the grass at the extreme edges as it rotates.

However, in a number of circumstances the wheels of the mower are not able to travel beyond the edge of the lawn, for example, due to the type of terrain beyond the edge of the lawn, due to a large drop in height between the lawn and the terrain beyond the edge of the lawn, or due to a solid object such as a wall being located at the edge of the lawn, and therefore the wheels have to remain on the lawn to maintain the correct operational position of the mower.

It is beneficial to mount the cutting deck of mowers on four wheels as it provides a stable platform on which the motor can be mounted for operation.

In order for such a mower to be able to cut the grass at the extreme edges of a lawn whilst maintaining the wheels on the lawn, the path swept out by the cutting blade must extend sideways beyond the wheels located closest to the edge of the lawn. This results in a cutting deck which forms a protective skirt around the path swept out by the cutting blade when it rotates, and which extends sideways even further than the path. In use, the wheels along one side of such a mower are moved over the lawn in close proximity to the edge of the lawn so that, the path swept out by the blade extends over and beyond the edge, to enable the blade to cut the grass at the extreme edges. Such a mower cannot be easily operated to cut grass located in close proximity to a solid object such as a tree or wall as the edge of the cutting deck is likely to come into contact with and be scratched or damaged by the wall or object.

In other circumstances, it is desirable for the sides of the deck to have a similar width to that of the wheels or to be narrower. For example, in certain circumstances it is desirable that the wheels of a mower do not traverse over the surface which has just been cut by the mower as it moves along. However, such a mower is unable to cut the extreme edge of a lawn whilst maintaining its wheels on the lawn.

### SUMMARY OF THE INVENTION

Accordingly, there is provided a lawn mower comprising a cutting deck mounted on castor wheel assemblies characterized in that the deck is mounted on four castor wheel assemblies, each located in the region of a corner of the cutting deck, and wherein a pair of castor wheel assemblies mounted on one edge of the cutting deck are located closer to each other than the pair of castor wheel assemblies located on the opposite edge of the cutting deck.

By arranging the castor wheel assemblies in this manner the cutting deck can be constructed so that its sides are the same as or less than the width as that of the wheel assemblies or narrower whilst allowing the mower to cut the grass at the extreme edge of a lawn. When the mower is manoeuvred in such a manner that the cutting deck is orientated at an angle relative to the direction of travel. The mower can be operated in the normal forward reverse manner thus providing a mower which has the benefits of having the sides of the deck located between the outer extremities of the assemblies. However, because the mower is mounted on castor wheel assemblies, it is able to be pushed along with the cutting deck at an angle to the direction of travel. Because one pair of wheels are located closer together than the other, the deck can be orientated relative to the direction of travel so that one of its edges can be located over the edge of the lawn whilst the wheels remain on the lawn.

Furthermore, when the mower is manoeuvred with the cutting deck at an angle to the direction of travel with the edge of the deck near to a wall or other object, the handle is located further away from the wall than if the mower was manoeuvred with the cutting deck orientated in the same direction as the direction of travel thus reducing the risk of the handle making contact with the wall or object.

Preferably, two castor wheel assemblies are located towards the front of the cutting deck and the other two are located towards the rear of the cutting deck. The pair of castor wheel assemblies located towards the front of the cutting deck can be located closer together than the pair of castor wheel assemblies located at the rear of the cutting deck. Alternatively, the pair of castor wheel assemblies located towards the rear of the cutting deck can be located closer together than the pair of castor wheel assemblies located at the front of the cutting deck. However, the castor wheel assemblies located on one side (i.e. left or right) could be closer together than the other side.

Preferably, the four castor wheel assemblies form the corners of a trapezium. This can provide a simple symmetrical construction.

Preferably, the side of the cutting deck projects sideways from the mower beyond a line formed by the outer edges of the castor wheel assemblies mounted on that side when that pair of castor wheel assemblies both have the same direction of travel on the same path. Ideally, the edge of the path swept out by the cutting blade when rotating projects sideways beyond the line formed by the outer edges of the castor wheel assemblies mounted on that side when that pair of castor wheel assemblies both have the same direction of travel on the same path. The side of the cutting deck preferably does not project sideways from the mower further than both castor wheel assemblies on that side of the mower when the mower is travelling in a forward and reverse direction. The edge of the path swept out by the blade when rotating ideally does not project sideways from the mower further than both castor wheel assemblies mounted on that side of the mower when the mower is travelling in a forward and reverse direction.

Ideally, at least one friction reduction mechanism is mounted on at least one side of the cutting deck that will enable the side of the cutting deck to engage with an object whilst reducing the risk of being damaged. When cutting near a wall or solid object, it can protect the sides of the deck from being damaged or scratched and therefore it can enable an operator to place the sides of the deck closer to the wall or object to cut the grass near the wall or object without fear of damaging the deck or object. The friction reduction mechanism can be arranged to allow the sides of the deck to slide along the side of the wall or object to prevent damage to it. The friction reduction mechanism can comprise at least one freely rotatable roller. The roller can be a single roller or a plurality of rollers either having a common axis of rotation or parallel axis of rotation. The axis of rotation of the rollers can be, and usually will be, vertical. The roller could be a single elongate roller or a wheel or plurality of wheels. The friction reduction mechanism can, instead of or in addition to the rollers, comprise at least one freely rotatable ball mounted within a socket. The ball may freely rotate within the socket in any direction. The ball could be a plurality of small balls located along the side of the deck, or a vertical or horizontal line of balls, or a single large ball.

The friction reduction mechanism preferably projects sideways from the mower beyond a line formed by the outer edges of the castor wheel assemblies mounted on that side, when the pair of castor wheel assemblies both have the same direction of travel on the same path. Preferably, the friction reduction mechanism does not project sideways from the mower further than both castor wheel assemblies mounted on that side of the mower when the mower is manoeuvred in a forward and reverse direction.

### BRIEF DESCRIPTION OF THE DRAWINGS

A lawn mower according to the present invention will now be described by way of example with reference to the accompanying drawing of which:

FIG. 1 is a side view of the lawn mower; and

FIG. 2 is a schematic view of the cutting deck mounted on the four castor wheel assemblies when viewed from above.

### DETAILED DESCRIPTION OF THE PREFERRED EMBODIMENTS

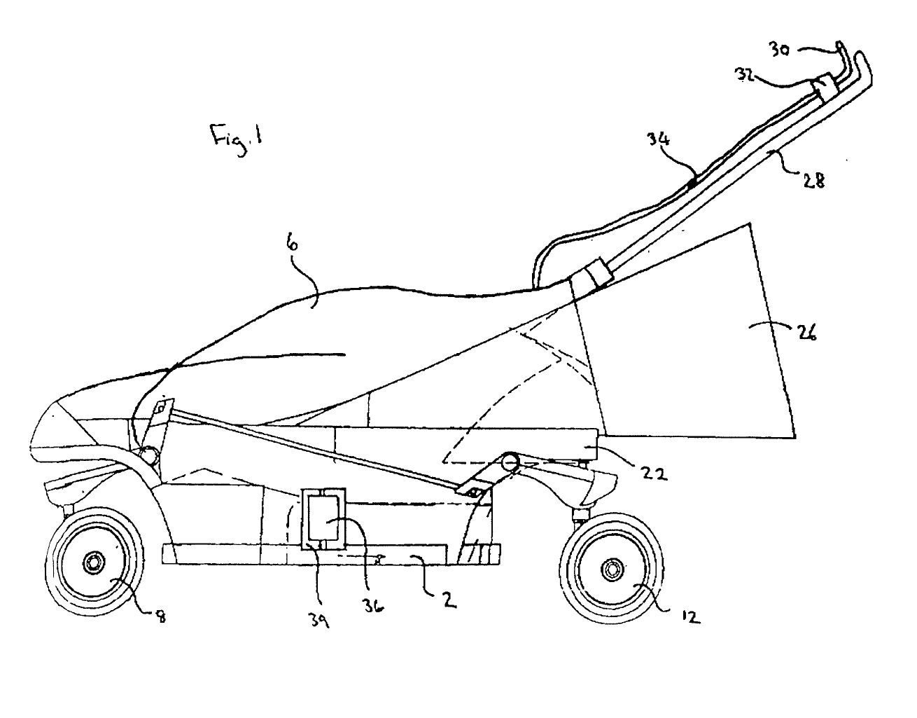

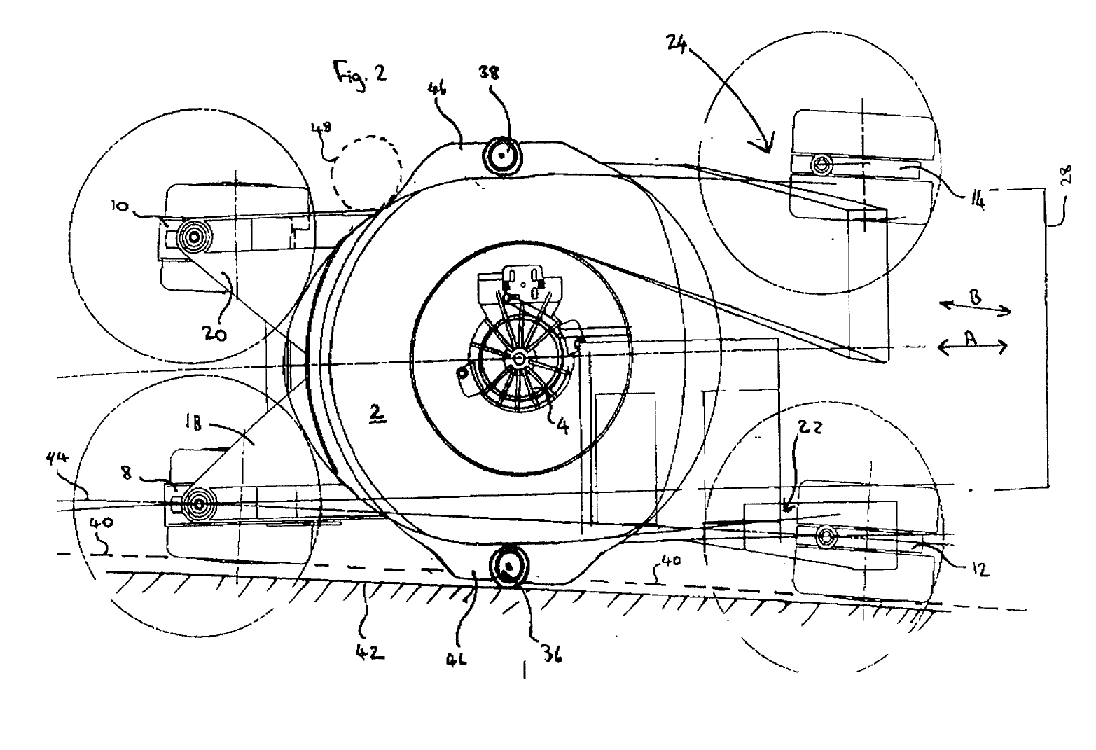

The first embodiment of the present invention will now be described. Referring to FIG. 1, the lawn mower comprises a cutting deck (2) upon which is mounted a motor (4) (as shown in FIG. 2). The motor (4) is powered by a battery (not shown). A hood (6) encloses the motor (4) and battery. The cutting deck (2) is mounted on four castor wheel assemblies (8, 10, 12, 14) located near to the four corners (18, 20, 22, 24) of the cutting deck (2). The motor (4) rotatingly drives a cutting blade (not shown) mounted below the cutting deck (2) on the output drive spindle of the motor (4) about a substantially vertical axis. A grass box (26) and a handle (28) are attached to the rear of the deck (2). Located on the handle (28) is a lever (30) which projects from a lever box (32) and which encloses an electric switch (not shown). An electric cable (34) runs from the lever box (32) to and then through the hood (6) into the body of the mower. An electric circuit (not shown) between the motor (4) and battery is completed by the activation of the electric switch by depression of the lever (30), thus energizing the electric motor (4).

On each side of the deck (2) between the forward (8, 10) and rear (12, 14) castor wheel assemblies is located a roller (36, 38) mounted within a socket (39) on the deck (2). The rollers (36, 38) are able to freely rotate about a vertical axis. The rollers (36, 38) can be located at any point along the side of the cutting deck (2) for example towards the front castor wheel assemblies as indicated by the dashed line (48).

Referring to FIG. 2, the front pair of castor wheel assemblies (8, 10) are located closer together than the rear pair (12, 14) the four castor wheel assemblies (8, 10, 12, 14) forming the four corners of a trapezium when viewed from above (as shown in FIG. 2). The side edges (46) of the cutting deck (2), the two rollers (36, 38), which project sideways beyond the edge (46) of the cutting deck (2) and the edge of the path swept out by the cutting blade (not shown) as it rotates all project beyond a line (40) formed by outer edges of the front and rear castor wheel assemblies (8,12) (shown as the two castor wheel assemblies (8,12) closest the wall (42) in FIG. 2) which have the same line of travel (44) i.e. they are travelling in the same direction on the same path (44), as opposed to the front and rear castor wheel assemblies (10, 14) located on the opposite side of the mower which are travelling in the same direction but on different paths (shown as the two castor wheel assemblies (10, 14) located furthest away from the wall (42) in FIG. 2). However, the edges (46) of the deck (2), the rollers (36, 38), and the edges of the path swept out by the cutting blade when it rotates, do not project sideways beyond both castor wheel assemblies, when mower is travelling in a forward and reverse direction.

In use the mower can be pushed or pulled in a forward or reverse direction (indicated by Arrow A) in the normal manner and thus again the benefits of a mower having the sides of the cutting deck (2) located between the rear castor wheel assemblies (12). However, if the operator wishes to locate the edge of the path swept out closer to the wall (42), the operator is able to push the deck (2) at an angle (indicated by Arrow B) as shown in FIG. 2. The roller (36) engages the wall (42) and prevents the side (46) of the deck (2) and the sides of the castor wheel assemblies (8, 12) from engaging with and thus being scratched or damaged by the wall (42). As the mower is pushed at an angle along the wall (42) the roller (36) freely rotates as it rolls along the wall (42).

Furthermore, as can be seen in FIG. 2 (shown schematically), the handle (28) is located further away from the wall (42) when the mower is pushed along the wall (42) with the cutting deck (2) at angle to the direction of travel (Arrow B) then if the mower is pushed in a forward and reverse direction (arrow A) thus reducing the risk of the handle and an operator's hand from being damaged by the wall.

It is obvious to a person skilled in the art that the line (42) shown in FIG. 2 which indicates a wall could also indicate the edge of a lawn. It is clear that by moving the mower with the deck (2) at an angle (as shown in FIG. 2), the edge of the cutting deck (2) and hence the edge of path swept out by the cutting blade when it rotates can be located closer to or over the edge of the lawn whilst maintaining the four castor wheel assemblies on the lawn.

In an alternative embodiment, the rollers are replaced by a number of spherical balls (not shown) mounted in sockets (not shown) formed in the side of the cutting deck (2) and which are able to freely rotate in any direction within their sockets. The spherical balls operate in a similar manner as the rollers (36, 38), to perform the same function.

What is claimed is:

1. A lawn mower comprising:
a cutting deck mounted on four castor wheel assemblies each located in a region of a corner of the cutting deck; and
wherein a pair of the castor wheel assemblies mounted on one edge of the cutting deck are located closer to each other than the other pair of castor wheel assemblies mounted on the opposite edge of the cutting deck.

2. A lawn mower as claimed in claim 1 wherein one pair of said castor wheel assemblies is located towards the front of the cutting deck and the other pair of castor wheel assemblies is located towards the rear of the cutting deck.

3. A lawn mower as claimed in claim 2 wherein the pair of castor wheel assemblies located towards the front of the cutting deck are located closer together than the pair of castor wheel assemblies is located towards the rear of the cutting deck.

4. A lawn mower as claimed in claim 2 wherein the pair of castor wheel assemblies located towards the rear of the cutting deck are located closer together than the pair of castor wheel assemblies located towards the front of the cutting deck.

5. A lawn mower as claimed in claim 1 wherein the four castor wheel assemblies form the corners of a trapezium.

6. A lawn mower as claimed in claim 1 wherein a side of the cutting deck projects sideways from the mower beyond a line formed by the outer edges of one of said pair of castor wheel assemblies mounted on the side when said pair of castor wheel assemblies have the same direction of travel on the same path.

7. A lawn mower as claimed in claim 1 wherein an edge of a path swept out by a cutting blade when rotating projects beyond a line formed by the outer edges of one of said pair of castor wheel assemblies mounted on a side when said pair of castor wheel assemblies have the same direction of travel on the same path.

8. A lawn mower as claimed in claim 1 wherein a side of the cutting deck does not project sideways from the mower further than one pair of said pair of castor wheel assemblies on the side of the mower when the mower is maneuvered in a forward and reverse direction.

9. A lawn mower as claimed in claim 1 wherein an edge of the path swept out by a cutting blade when rotating does not project sideways from the mower further than one of said pair of castor wheel assemblies mounted on the side of the mower when the mower is manoeuvred in a forward and reverse direction.

10. A lawn mower as claimed in claim 1 wherein at least one friction reduction mechanism is mounted on at least one side of the cutting deck.

11. A lawn mower as claimed in claim 10 wherein the friction reduction mechanism comprises at least one freely rotatable roller.

12. A lawn mower as claimed in claim 10 wherein the friction reduction mechanism comprises at least one freely rotatable ball mounted within a socket.

13. A lawn mower as claimed in claim 10 wherein the friction reduction mechanism projects sideways from the mower beyond a line formed by the outer edges of one of said pair of castor wheel assemblies mounted on a side of the mower when said pair of castor wheel assemblies have the same direction of travel on the same path.

14. A lawn mower as claimed in claim 10 wherein the friction reduction mechanism does not project sideways from the mower further than one of said pair of castor wheel assemblies mounted on a side of the mower when the mower is maneuvered in a forward and reverse direction.
